(19) United States
(12) Patent Application Publication
(10) Pub. No.: US 2009/0192882 A1
(43) Pub. Date: Jul. 30, 2009

(54) CUSTOMER BEHAVIOR MONITORING SYSTEM, METHOD, AND PROGRAM

(75) Inventors: Masaki NARAHASHI, Tokyo (JP); Takashi KOISO, Kanagawa (JP); Masami TAKAHATA, Tokyo (JP); Tomonori IKUMI, Shizuoka (JP)

Correspondence Address: HARNESS, DICKEY & PIERCE, P.L.C., P.O. BOX 828, BLOOMFIELD HILLS, MI, 48303, US

(73) Assignee: TOSHIBA TEC KABUSHIKI KAISHA, Tokyo (JP)

(21) Appl. No.: 12/393,355

(22) Filed: Feb. 26, 2009

Related U.S. Application Data
(63) Continuation of application No. PCT/JP2008/061479, filed on Jun. 24, 2008.

(30) Foreign Application Priority Data
Jun. 26, 2007 (JP) 2007-167938
Dec. 21, 2007 (JP) 2007-331125

(51) Int. Cl. G06Q 10/00; G06Q 30/00; G06F 17/30; G06F 17/40; G06N 5/02

(52) U.S. Cl. 705/10; 705/26; 707/104.1; 706/52; 707/E17.044

(57) ABSTRACT

A flow line storage stores flow line data of each customer obtained by tracking a behavior of each customer in a store, by adding time data on an estimated time of payment made by each customer. A transaction data storage stores transaction data for each customer including records of items purchased by each customer, by adding time data on an estimated time of payment made by each customer. A combination unit determines a combination in which a difference between time data is minimum, for each piece of flow line data stored in the flow line storage and each piece of transaction data stored in the transaction data storage. A correlating unit correlates the flow line data and transaction data combined by the combination unit.

### CROSS-REFERENCE TO RELATED APPLICATIONS

This is a Continuation Application of PCT Application No. PCT/JP2008/061479, filed Jun. 24, 2008, which was published under PCT Article 21(2) in Japanese.

This application is based upon and claims the benefit of priority from prior Japanese Patent Applications No. 2007-167938, filed Jun. 26, 2007; and No. 2007-331125, filed Dec. 21, 2007, the entire contents of both of which are incorporated herein by reference.

### BACKGROUND OF THE INVENTION

1. Field of the Invention

The present invention relates to a system and method, which monitor the behavior of customers in a store by correlating with merchandise purchased by customers.

2. Description of the Related Art

There is a known conventional system which uses data about flow lines of people for monitoring behavior of customers in a store by correlating with merchandise purchased by customers.

Jpn. Pat. Appln. KOKAI Publication No. 2006-350751 discloses a system which identifies and displays data on a flow line of a customer specified as an object according to the time of payment made by the customer, when the object customer is identified by selecting one of purchase information from a purchase information database.

Jpn. Pat. Appln. KOKAI Publication No. 2007-087208 discloses a system, in which whenever a customer finishes payment, data on a flow line of a customer existing in a checkout lane at that time is correlated with purchase information at that time.

### BRIEF SUMMARY OF THE INVENTION

The above patent applications do not disclose reasons for identifying flow line data to be correlated with purchase information. Thus, it is uncertain that flow line data correlated with purchase information is the actual data relating to a specified customer.

Therefore, a customer behavior monitoring system which can exactly correlate flow line data on a customer with purchase information about the customer is demanded.

According to an aspect of the invention, there is provided a customer behavior monitoring system comprising a flow line storage which stores flow line data on each customer obtained by tracking behavior of each customer in a store, by adding time data on an estimated time of payment made by each customer; a transaction data storage which stores transaction data for each customer including records of merchandise purchased by each customer, by adding time data on an estimated time of payment made by each customer; a combination unit which determines a combination in which a difference between the time data is minimum, for each flow line data stored in the flow line storage and each transaction data stored in the transaction data storage; and a correlating unit which correlates the flow line data and transaction data combined by the combination unit.

### BRIEF DESCRIPTION OF THE SEVERAL VIEWS OF THE DRAWING

FIG. 1 is a block diagram of a system according to an embodiment of the invention;

FIG. 2 shows a configuration of a transaction record stored in a transaction database according to an embodiment of the invention;

FIG. 3 shows a configuration of a flow line record stored in a flow line database according to an embodiment of the invention;

FIG. 4 shows a primary data table formed in a data storage of a customer behavior monitoring system, in a first embodiment;

FIG. 5 is a flowchart showing steps of a main process executed by a control unit of a customer behavior monitoring system according to a customer behavior monitoring program, in a first embodiment;

FIG. 6 is a flowchart showing steps of a process of acquiring a transaction ID list in FIG. 5;

FIG. 7 shows an example of a database language SQL for extracting a transaction ID in a predetermined correlating period;

FIG. 8 is a flowchart showing steps of a process of acquiring a flow line ID list in FIG. 5;

FIG. 9 is a flowchart showing steps of a process of automatic flow line-transaction correlating in FIG. 5;

FIG. 10 is a flowchart showing steps of a process of manual flow line-transaction correlating in FIG. 5;

FIG. 11 shows an example of a transaction ID list table formed in a first embodiment;

FIG. 12 shows an example of a flow line ID list table formed in a first embodiment;

FIG. 13 shows an example of a correlate table formed in a first embodiment;

FIG. 14 is a flowchart showing steps of a main process executed by a control unit of a customer behavior monitoring system according to a customer behavior monitoring program, in a second embodiment of the invention;

FIG. 15 shows an example of a second correlate table formed in a data storage, in a second embodiment;

FIG. 16 shows an example of a terminal number table formed in a data storage, in a third embodiment of the invention;

FIG. 17 is a flowchart showing steps of a second process of manual flow line-transaction correlating, in a third embodiment;

FIG. 18 shows an example of a primary data table formed in a data storage of a customer behavior monitoring system, in a fourth embodiment;

FIG. 19 is a flowchart showing steps of a main process executed by a control unit of a customer behavior monitoring system according to a customer behavior monitoring program, in a fourth embodiment;

FIG. 20 is a flowchart showing steps of an accessed flow line correlating process in FIG. 19;

FIG. 21 shows an example of a merchandise selling space information table formed in a fourth embodiment;

FIG. 22 is a diagram showing an example of a floor layout in a store displayed in a fourth embodiment;

FIG. 23 shows an initial state of a group customer table formed in a fourth embodiment; and

FIG. 24 shows a state after assignment of accessed flow line ID of a group customer table formed in a fourth embodiment.

### DETAILED DESCRIPTION OF THE INVENTION

Hereinafter, a best mode for carrying out the invention will be explained by referring to the accompanying drawings.

### Embodiment 1

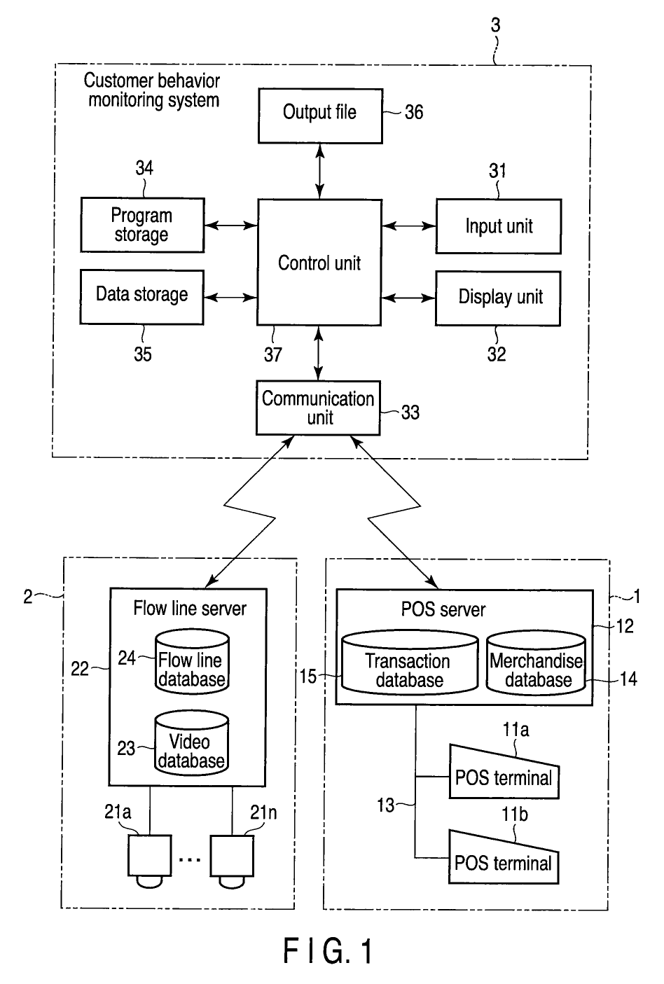

This embodiment comprises a sales management system 1, a flow line data management system 2, and a customer behavior monitoring system 3, as shown in FIG. 1.

The sales management system 1 includes a plurality of POS terminals 11a and 11b and a single POS server 12. The POS terminals 11a and 11b are installed in appropriate locations in a store. The POS server 12 functions as a host to the POS terminals 11a and 11b. The POS server 12 connects the POS terminals 11a and 11b through a communication circuit 12 such as a local area network (LAN). The sales management system 1 configured as above is generally called a POS system.

The POS terminals 11a and 11b function as transaction payment terminals. Namely, when data on merchandise purchased by a customer is input, the POS terminals 11a or 11b enters sales data on the merchandise. When data on the money paid by the customer is input, the POS terminal issues a receipt, and settle the transaction with the customer.

Each time transaction is settled, the POS terminals 11a and 11b generate data indicating the purchased contents, so called transaction data. Transaction data includes detailed information about a transaction, a terminal number, transaction date and time, a serial number of a transaction, and a person-in-charge code. The detailed information about a transaction includes a merchandise code, a merchandise name, a unit price, number of purchased merchandise items, and sale amount of purchased merchandise.

Each POS terminal 11a and 11b is provided with a clock IC. When data on the first item of the merchandise purchased by a customer is input, the POS terminal 11a or 11b sets the date and time counted by the clock IC in the transaction data as transaction date and time. When a checkout key such as a cash in/cash total key is operated, each POS terminal 11a and 11b may set the date and time in transaction data as transaction date and time.

Each POS terminal 11a and 11b stores a specific terminal number in a memory as terminal identifying information. The POS terminal also stores a person-in-charge code and transaction serial number for identifying a casher, who is an operator, in a memory. A transaction serial number is counted up, each time transaction is settled. Each POS terminal 11a and 11b sets the terminal number, person-in-charge code, and transaction serial number in transaction data.

The POS server 12 has a merchandise database 14, and a transaction database 15.

The merchandise database 14 stores merchandise information such as a code, a name, and a unit price of each item of merchandise sold in a store. Based on the merchandise information stored in the merchandise database 14, each POS terminals 11a and 11b generates transaction data.

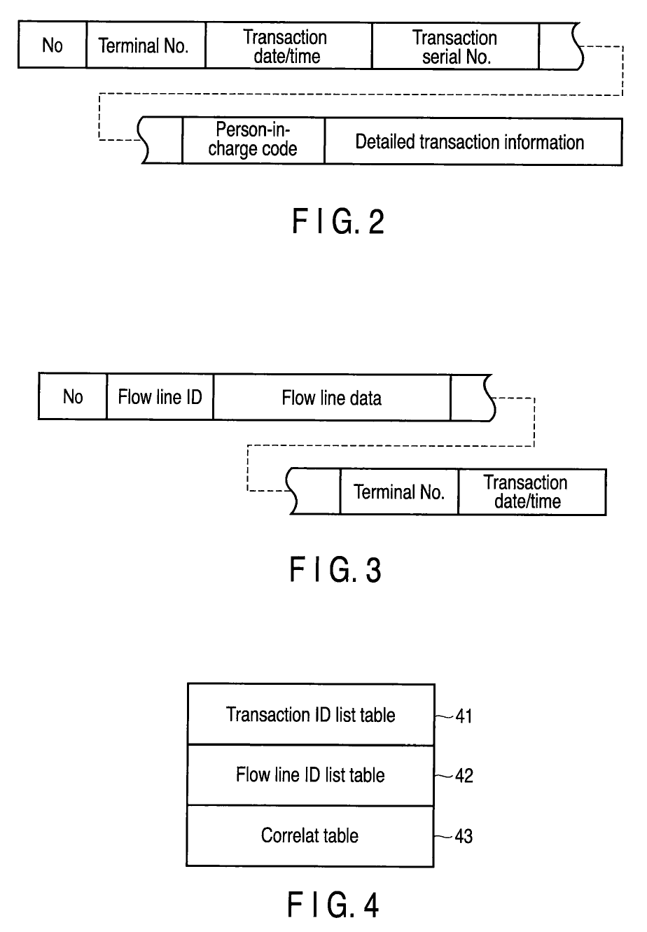

The transaction database 15A stores a transaction record having a data structure shown in FIG. 2. A transaction record consists of data items, such as a record number, a terminal number, transaction date and time, a transaction serial number, a person-in-charge code, and detailed information about a transaction. Transaction data consists of a terminal number, transaction date and time, a transaction serial number, a person-in-charge code, and detailed information about a transaction.

Whenever receiving transaction data from the POS terminal 11a or 11b through the communication circuit 13, the POS server 12 generates a transaction record from the transaction data, and stores the transaction record in the transaction database 15 in ascending order of record number.

Transaction data is uniquely identified by combination of a terminal number, transaction date and time, and a transaction serial number. Therefore, a terminal number, transaction date and time, and a transaction serial number, function as an ID of transaction data. Hereinafter, data used as an ID of transaction data is called a transaction ID.

The flow line management system 2 consists of cameras 21a to 21n, and a moving server 22. The cameras 21a to 21n are installed at appropriate locations able to shoot substantially all areas in a store.

The flow line server 22 has a video database 23, and a flow line database 24. Video data taken by the cameras 21a to 21n is stored in the video database 23. Each time the video data taken by the cameras 21a to 21n is captured, the flow line server 22 adds shooting date/time data to the increased video data. The flow line server 22 stores the video data with the shooting date/time data in the video database 23.

A record of a flow line having a data structure shown in FIG. 3 is stored in the flow line database 24. A record of a flow line consists of data items such as a record number, a flow line ID, flow line data, a terminal number, and transaction date and time.

Based on the video data stored in the video database 23, the flow line server 22 generates flow line data for each customer. Flow line data means the data obtained by following the course the customer moves from the entry to the exit of a store. The flow line server 22 sets a specific flow line ID for the data of each flow line. The flow line server 22 saves the flow line data attached with a flow line ID in the flow line database 24 in ascending order of record number.

The flow line server 22 is provided with an input device such as a mouse or a keyboard and a display unit such as a liquid crystal display. When an operator operates the input device for selecting desired flow line data from the flow line database 24, the flow line based on the selected flow line data is displayed on the display unit. In synchronization with the flow line, images captured by the cameras 21a to 21n are displayed on the display unit.

An operator can monitor the behavior of the customer by following the flow line while confirming the displayed images. When an operator recognizes an estimated time when the customer makes payment at a checkout place, an operator inputs the terminal number of the POS terminal 11a or 11b installed at the checkout place, from the input device. When the terminal number is input, the flow line server 22 adds the date/time and terminal number at the time of the operation, to the selected flow line data.

An operator executes the above operation for all flow line data passing through a checkout lane, among the flow line data stored in the flow line database 24. Thereby, an operator can add the estimated time data indicating the payment made by a customer corresponding to the flow line data, and terminal information (a terminal number) to identify the payment terminal (the POS terminal 11a or 11b), to each flow line data.

The customer behavior monitoring system 3 comprises an input unit 31, a display unit 32, a communication unit 33, a program storage 34, a data storage 35, an output file 36, and a control unit 37. The communication unit 33 has an interface function with the POS server 12 and flow line server 22. Such a system can be realized by a computer system, such as a personal computer.

Namely, input devices such as a keyboard and a mouse are used as an input unit 31. Display devices such as a liquid crystal display and a CRT display are used as a display unit 32. An ordinary communication interface provided in a computer system is used as a communication unit 33. A read-only memory (ROM) is used as a program storage 34. A random access memory (RAM) is used as a data storage 35. A hard disk drive (HDD) is used as an output file 36.

The customer behavior monitoring system 3 ensures a memory area shown in FIG. 4, that is, a transaction ID list table 41, a flow line ID list table 42, and a correlate table 43, in the data storage 35. The customer behavior monitoring system 3 stores a customer behavior monitoring program according to the invention, in the program storage 24.

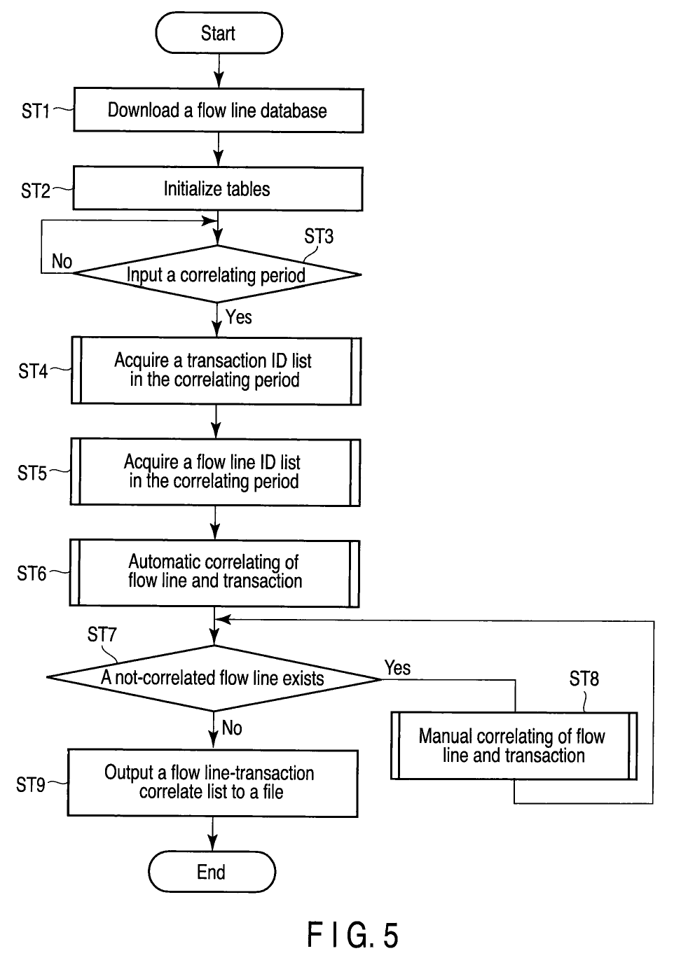

A customer behavior monitoring program is started by an instruction to execute monitoring of customer behavior. When a customer behavior monitoring program is started, the control unit 37 starts a main process shown in the flowchart of FIG. 5.

The control unit 37 requests the flow line server 22 to download the flow line database 24, as step ST1. Receiving the request, the flow line server 22 downloads the data of the flow line database 24 to the customer behavior monitoring system 3. The data of the flow line database 24 downloaded through the communication unit 33 is stored in the data storage 35.

The control unit 37 initializes the transaction ID list table 41, flow line ID list table 42, and correlate table 43, as step ST2.

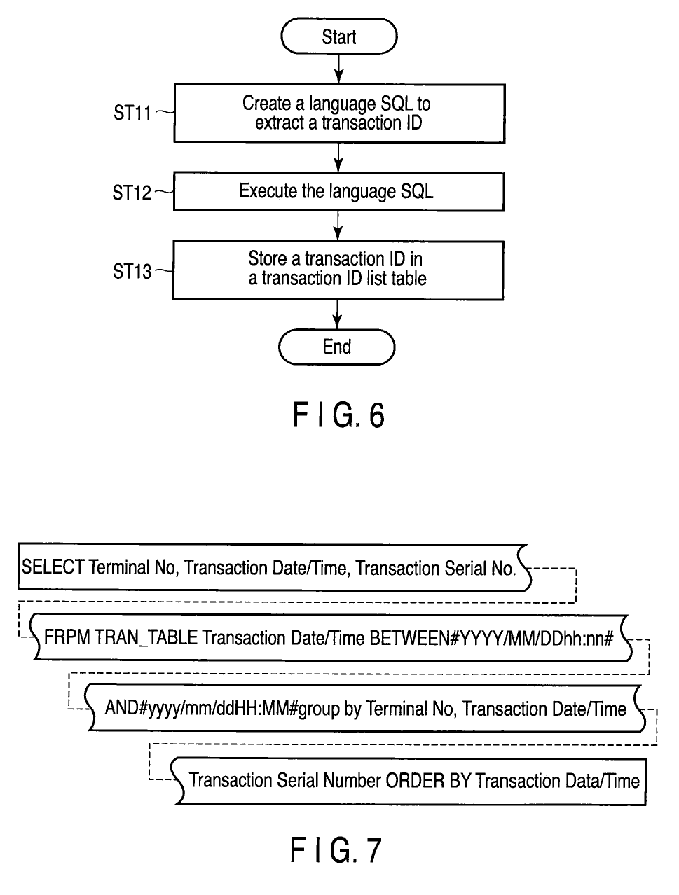

The control unit 37 waits for entry of a period of correlating the flow line data and transaction data, as step ST3. When the start and end dates and time of the correlating period are input through the input unit 31, the control unit 37 executes a transaction ID list acquisition process in that period, as step ST4. Steps of this process are concretely shown in the flowchart of FIG. 6.

The control unit 37 creates a database language SQL for extracting transaction IDs in a correlating period. FIG. 7 shows an example of database language SQL. The database language SQL is used to retrieve transaction IDs from the transaction database 15, and arrange the transaction ID in ascending order of transaction date and time.

After creating a database language SQL, the control unit 37 executes the database language SQL for the POS server 12, as step ST12. After the database language SQL is executed, the transaction database 15 of the POS server 12 is retrieved. And, a transaction ID, that is, a terminal number, transaction date and time, and a transaction serial number, is extracted from a transaction record in which transaction date and time are within the specified period.

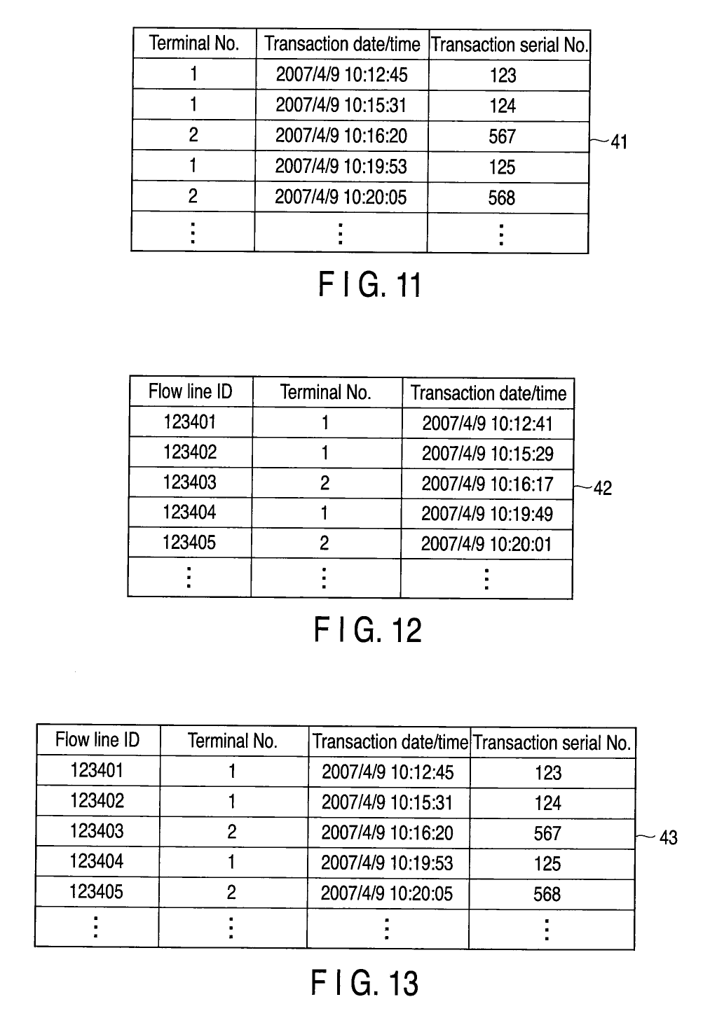

After extracting the data as a transaction ID, the control unit 37 stores the extracted data in the transaction ID list table 41, as step ST13. In this way, a transaction ID consisting of a terminal number, transaction date and time and a transaction serial number is stored in list form in the transaction ID list table 41. FIG. 11 shows an example of a transaction ID list. As shown in the drawing, a transaction ID list is stored in ascending order of transaction date and time.

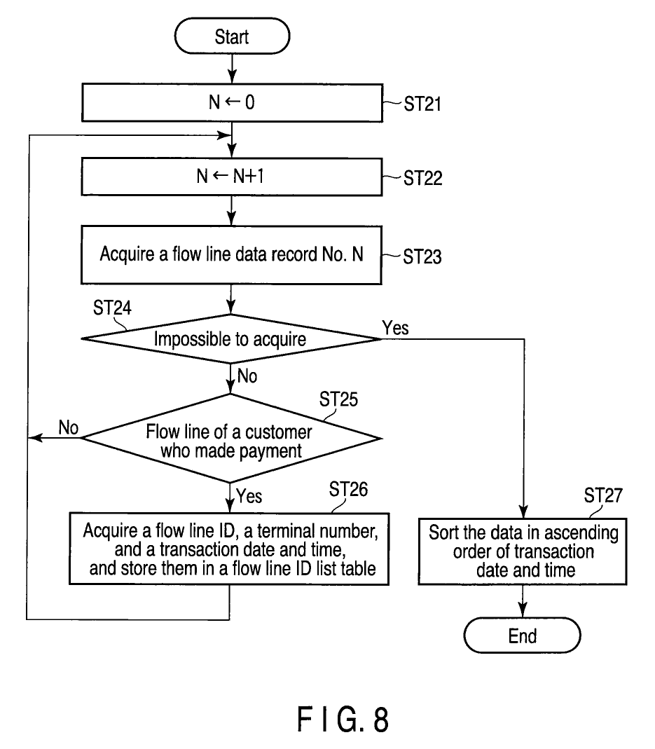

A transaction ID list acquisition process is now finished. After a transaction ID list acquisition process is finished, the control unit 37 executes a flow line ID list acquisition process within a correlating period, as step ST5. Steps of this process are concretely shown in the flowchart of FIG. 8.

The control unit 37 resets a selling space N to “0”, as step ST21. After resetting the selling space N to “0”, the control unit 37 counts up the selling space N by “1”, as step ST22.

The control unit 37 regards a value of the selling space N as a record number, as step ST23. And, the control unit retrieves a flow line record of the record number N from the data of the flow line database 24 downloaded to the data storage 35.

The control unit 37 determines whether the flow line record of the record number is acquired, as step ST24. When the flow line record is acquired, the control unit 37 determines whether a flow line record indicates behavior of a customer who made payment, as step ST25.

When the flow line record includes a terminal number and transaction date and time, the flow line record is of a customer who made payment. In this case, the control unit 37 extracts a flow line ID, terminal number and transaction date and time from the flow line record, as step ST26. And, the control unit stores the extracted data in the flow line ID list table 42. Then, the control unit 37 returns to step ST22.

If the flow line record does not include a terminal number and transaction date and time, the flow line record is of a customer who did not make payment. In this case, the control unit 37 does not execute step ST26. The control unit 37 returns to step ST22.

The control unit 37 repeats steps ST22 to ST26 by a number of times equal to the number of flow line records stored in the flow line database 24.

If a flow line record of a record number N is not retrieved from the flow line database 24, the control unit 37 sorts the data of the flow line ID list table 42 in ascending order of transaction date and time, as step ST27. In this way, a flow line ID list, consisting of a flow line ID of a customer who made payment, a terminal number, and transaction date and time, is stored in the flow line ID list table 42. FIG. 12 shows an example of a flow line ID list. As shown in the drawing, a flow line ID list is stored in ascending order of transaction date and time.

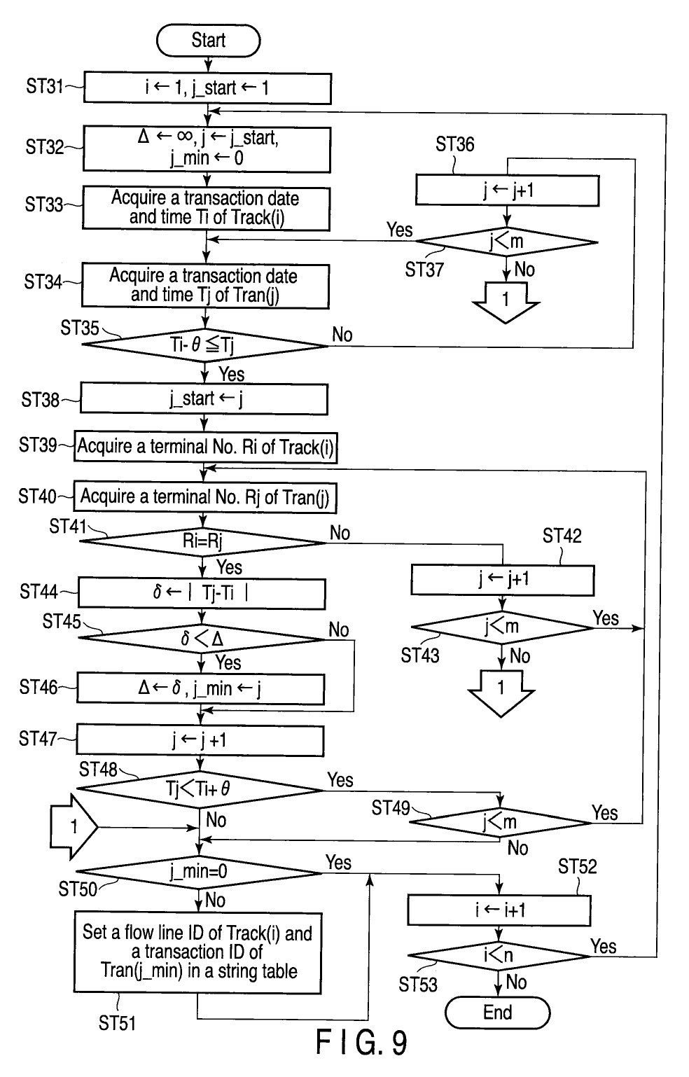

A transaction ID list acquisition process is now finished. After a transaction ID list acquisition process is finished, the control unit 37 executes automatic correlating of flow line data and transaction data, as step ST6. Steps of this process are concretely shown in the flowchart of FIG. 9.

In FIG. 9, “Track(i)” indicates data in a flow line ID list, so-called flow line ID data (a flow line ID, a terminal number, and transaction date and time). The suffix “i” indicates an integer from “1” to “n” (“n” is the number of pieces of data in a flow line ID list).

“Tran(j)” indicates data in a transaction ID list, so-called transaction ID data (a terminal number, transaction date and time, and a transaction serial number). The suffix “j” indicates an integer from “1” to “m” (“m” is the number of pieces of data in a transaction ID list).

“θ” indicates a time range (−θ to +θ) for a transaction date and time to be correlated. The time range “θ” is optionally set by the user before starting operations. “δ” indicates an absolute value of the difference between transaction dates and time to be correlated. “Δ” indicates a minimum of an absolute value “δ”. “j_min” indicates a numeric value j when a minimum of an absolute value “δ” is a minimum value. “j_start” is a numerical value j at a position of starting comparison of transaction dates and time.

When the automatic correlating process is started, the control unit 37 sets the numeric values i and j_start to “1”, as step ST31. The control unit sets the minimum value Δ to infinity, the numeric value j to the numeric value j_start, and the numeric value j_min to “0”, respectively, as step ST32.

The control unit 37 retrieves the flow line ID data Track(i) from the flow line ID list table 42, as step ST33, and extracts transaction date and time T1 from the flow line ID data Track(i). The control unit 37 retrieves a transaction ID Tran(j) from the transaction ID list table 41, as step ST34, and extracts a transaction date and time Tj from the transaction ID Tran(j).

The control unit 37 determines whether or not the transaction date and time Tj reaches the date and time “T1−θ”, transaction date and time T1 minus time range θ. If not, the control unit 37 counts up the numeric value j by “1”, as step ST36. After counting up the numeric value j, the control unit 37 determines whether or not the numeric value j exceeds the number m of transaction IDs, as step ST37. If not, the control unit 37 returns to step ST34.

Namely, the control unit 37 retrieves the transaction ID Tran(j) from the transaction ID list table 41. The control unit extracts a transaction date and time Tj from the transaction ID Tran(j), and compares it with the date and time “T1−θ”.

When the transaction date and time Tj reaches the date and time “T1−θ” (YES in step ST35), the control unit 37 replaces the numeric value j_start with the numeric value J at the present time, as step ST38.

The control unit 37 extracts a terminal number Ri from the flow line ID data Tran(j), as step ST39, and extracts a terminal number Rj from the transaction ID Tran(j), as step ST40.

The control unit 37 determines whether or not the terminal number Rj coincides with the terminal number Ri, as step ST41. If not, the control unit 37 counts up the numeric value j by “1”, as step ST42. After counting up the numeric value j, the control unit 37 determines whether or not the numeric value j exceeds the number of pieces of data m, as step ST43. If not, the control 37 returns to step ST40.

Namely, the control unit 37 retrieves the transaction ID Tran(j) from the transaction ID list table 41. The control unit 37 obtains a terminal number Rj from the transaction ID Tran(j), and compares it with the terminal number Ri.

When the terminal number Rj coincides with the terminal number Ri (YES in step ST41), the control unit 37 retrieves transaction date and time Ti from the flow line ID data Track(i), as step ST44, and extracts the transaction date and time Tj from the transaction ID Tran(j). Then, the control unit calculates the absolute value δ of the difference between the transaction date and time Tj and the transaction date and time Ti.

The control unit 37 compares the absolute value δ with the minimum value Δ, as step ST45. When the absolute value δ is smaller than the minimum value Δ, the control unit 37 replaces the minimum value Δ with the absolute value δ, as step ST46, and replaces the numeric value j_min with the numeric value j. When the absolute value δ is larger than the minimum value Δ, the control unit 37 does not perform the operation of step ST46.

The control unit 37 counts up the numeric value j by “1”, as step ST47. After counting up the numeric value j, the control unit 37 retrieves a transaction ID Tran(j) from the transaction ID list table 41, and extracts transaction date and time Tj from the transaction ID Tran(j).

The control unit 37 determines whether or not the transaction date and time Tj reaches the date and time “Ti+θ”, transaction date and time Ti plus time range θ, as step ST48. If not, the control unit 37 determines whether or not the numeric value j exceeds the number of pieces of data m, as step ST49. If not, the control unit returns to step ST40.

Namely, the control unit 37 extracts the terminal number Rj from the transaction ID Tran(j). The control unit 37 determines whether or not the terminal number Rj coincides with the terminal number Ri. If not, the control unit executes the operations of steps ST42 and ST43. When the terminal numbers are matched, the control unit executes the operations of steps ST44 to ST49.

When the transaction date and time Tj of the transaction ID Tran(j) reaches the date and time “Ti+θ” (NO in step ST48), or when the numeric value j exceeds the number of pieces of data m (NO in steps ST37, ST43, and ST49), the control unit 37 determines whether or not the numeric value j_min is unchanged from “0”, as step ST50.

If the numeric value j_min is not “0”, the control unit 37 executes the operation of step ST51. Namely, the control unit 37 extracts a flow line ID from the flow line ID data Track(i), and extracts a terminal number, transaction date and time, and a transaction serial number from the transaction ID Tran(j_min). Then, the control unit 37 stores the flow line ID, terminal number, transaction date and time, and transaction serial number as one record in the correlate table 43.

When the operation of step ST51 is finished, or when the integer j_min is unchanged from “0”, the control unit 37 counts up the numeric value i by “1”, as step ST52. The control unit determines whether or not the numeric value i exceeds the number of flow line ID data n, as step ST53. If not, the control unit returns to step ST32.

Namely, the control unit 37 sets the minimum value Δ to infinity, the numeric value j to the numeric value j_start, and the numeric value j_min to “0”, respectively. The control unit retrieves a flow line ID data Track(i) from the flow line ID list table 42, and executes the operations of steps ST33 to ST53.

When the numeric value i exceeds the number of pieces of flow line ID data n (No in step ST53), the control unit 37 finishes the automatic correlating process.

The customer behavior monitoring system 3 sequentially retrieves the flow line ID data Track(i) corresponding to the numeric value “i” from the flow line ID list table 42. Each time the flow line ID data Track(2) is obtained, the customer behavior monitoring system executes the following operations.

First, the customer behavior monitoring system sets the time range 2θ (“Ti−θ” to “Ti+θ”) around the transaction data and time Ti of the flow line ID data Track(i). Then, the system assumes a value within the time range 2θ as transaction date and time Tj, and retrieves the transaction ID Tran(j) having the same terminal number Rj as the terminal number Ri of the flow line ID data Track(i), from the transaction ID list table 41.

When the transaction ID Tran(j) is detected as a result, the customer behavior monitoring system 3 calculates an absolute value δ of the difference between the transaction date and time Tj of the transaction ID Tran(j) and the transaction date and time Ti of the flow line ID data Track(i). And, the system stores the numeric value j of the transaction ID Tran(j) when the absolute value δ is minimum, as a numeric value j_min.

When the numeric value j_min is defined, the customer behavior monitoring system 3 determines the transaction ID Tran(j_min) to be data to be combined with the flow line ID data Track(i) (a combination unit). The customer behavior monitoring system 3 stores the flow line ID of the flow line ID data Track(i), and the terminal number, transaction date and time and transaction serial number of the transaction ID Tran(j_min), as one record in the correlate table 43. Namely, the customer behavior monitoring system executes correlating of the flow line data specified by the flow line ID data Track(i) and the transaction data specified by the transaction ID Tran(j_min) (a correlating unit).

FIG. 13 shows an example of data stored in the correlate table 43. This example corresponds to the data of the transaction ID list table 42 shown in FIG. 11 and the data of the flow line ID list table 42 shown in FIG. 12.

After the automatic correlating process is finished, the control unit 37 determines whether or not any flow line data not correlated with a transaction ID exists, as step ST7. The control unit 37 collates each flow line ID set in the flow line ID list table 42 with each flow line ID set in the correlate table 43. A transaction ID is not correlated with a flow line ID not existing in the correlate table 43.

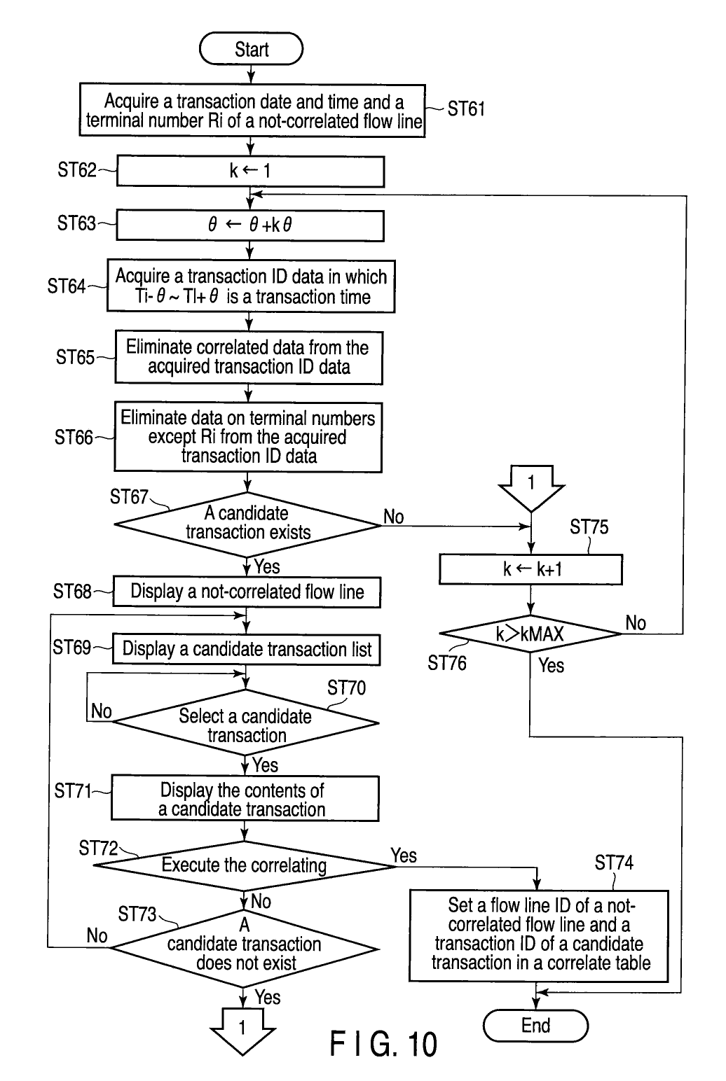

After detecting a flow line ID not correlated with a transaction ID, a so-called non-correlated flow line ID, the control unit 37 executes manual correlating process of flow line data and transaction data, as step ST8. Steps of this process are concretely shown in the flowchart of FIG. 10.

In FIG. 10, “k” indicates the number of repetitions, and “kMAX” indicates a maximum number of repetitions k. The number of repetitions k and maximum number kMAX are optionally set by the user before starting operations.

When the manual correlating process is started, the control unit 37 retrieves the transaction data and time Ti and terminal number Ri corresponding to the non-correlated flow line ID, from the flow line ID list table 42, as step ST61. The control unit 37 initializes the number of repetitions k to “1”, as step ST62.

The control unit 37 multiplies the time range θ at the present time by the number of repetitions k, and adds the product to the time range θ, as step ST63. Namely, when the number of repetitions k is “1”, the control unit expands the time range θ by two times. When the number of repetitions k is “2”, the control unit expands the time range θby three times.

The control unit 37 calculates the date and time “Ti−θ”, transaction date and time Ti minus time range θ after the expansion, as step ST64. The control unit 37 calculates the date and time “Ti+θ”, transaction date and time Ti plus time range θ after the expansion. And, the control unit 37 retrieves transaction IDs within the period in which the transaction date and time Tj is in a range of “Ti−θ” to “Ti+θ”, from the transaction ID list table 41, as correlating candidates.

After obtaining transaction IDs as correlating candidates, the control unit 37 abandons transaction IDs satisfying the following conditions among the candidates, as step ST65 and step ST66. The control unit abandons a transaction ID already set in the correlate table 43, in step ST65, and abandons a transaction ID having a terminal number Rj different from a terminal number Ri, in step ST66.

The control unit 37 checks whether or not a transaction ID as a correlate candidate remains, as step ST67. When a candidate transaction ID remains, the control unit 37 acquires flow line data of a non-correlated flow line ID from the data storage 35. Data of the flow line database 24 has been downloaded in the data storage 35.

The control unit 37 displays a flow line based on the flow line data in the display unit 32, as step ST68. The control unit 37 displays a list of transaction IDs as correlating candidates, a so-called candidate transaction list, in the display unit 32, as step ST69. For example, the screen of the display unit 32 is divided into two areas, and a flow line is displayed on one area, and a candidate transaction list is displayed on the other area.

The control unit 37 waits until any one of transaction IDs is selected from the candidate transaction list, as step ST70.

When any one transaction ID is selected through the input unit 31, the control unit 37 inquires the POS server 12 about the transaction data specified by the transaction ID selected in step ST71. When the POS server 12 returns the transaction data as a response to the inquiry, the control unit 37 displays the contents of the data, that is, the name, etc. of a purchased merchandise item in the display unit 32. The contents of the transaction data are displayed instead of a candidate transaction list.

The operator estimates a customer's purchasing behavior according to a customer's flow line, and determines whether or not the transaction data is of an object customer. When the transaction data is of an object customer, the operator presses the execute key in the input unit 31. If not, the operator presses the cancel key in the input unit 31.

The control unit 37 waits until the execution key or the cancel key is pressed, as step ST72. When the cancel key is pressed (NO in step ST72), the control unit 37 determines whether or not another transaction ID exists as a correlating candidate, as step ST73. When another candidate transaction ID exists, the control unit returns to step ST69.

When the execute key is pressed (YES in step ST72), the control unit 37 determines the selected transaction ID as a correlating object, as step ST74. The control unit 37 stores a non-correlated flow line ID and a transaction ID decided as a correlating object in the correlate table 43, as one record. Now, the manual correlating process for a flow line ID not correlated with a transaction ID is finished.

When no transaction ID remains as a correlating candidate (NO in step ST67), or when a transaction ID as a correlating candidate is used up (YES in step ST73), the control unit 37 counts up the number of repetitions k by “1”, as step ST75.

After counting up the number of repetitions k, the control unit 37 determines whether or not the number of repetitions k exceeds a maximum value kMAX, as step ST76. When the number of repetitions k does not exceed a maximum value kMAX, the control unit 37 returns to step ST63. Namely, the control unit 37 expands the time range θ furthermore, and repeats the operations at and after step ST64.

When the number of repetitions k exceeds a maximum value kMAX, the manual correlating process is finished. In this case, a transaction ID is not correlated with a non-correlated flow line ID.

The control unit 37 executes the above manual correlating process whenever detecting a non-correlated flow line ID (YES in ST7). After executing the manual correlating process for all non-correlated flow line IDs (NO in ST7), the control unit 37 outputs a correlate list of flow line IDs and transaction IDs stored in the correlate table 43, to the output file 36, as step ST9. Now, the customer behavior monitoring program is finished.

As explained above, the customer behavior monitoring system 3 executes the following processes according to the customer behavior monitoring program. Namely, the customer behavior monitoring system 3 creates a transaction ID list, based on the transaction data stored in the transaction database 15 of the sales management system 1. The customer behavior monitoring system 3 creates a flow line ID list, based on the flow line data stored in the flow line database 24 of the flow line data management system 2.

After creating the transaction ID list and flow line ID list, the customer behavior monitoring system 3 determines a combination of a flow line ID and transaction ID of both lists in which terminal numbers are matched and a difference between transaction dates and time is minimum. Then, the customer behavior monitoring system 3 stores the combined flow line ID and transaction ID in the correlate table 43, as one record.

Therefore, the flow line data specified by a flow line ID stored in the correlate table 43 is correlated with the transaction data specified by a transaction ID combined which constitutes one record together with the flow line ID.

As described above, in the customer behavior monitoring system 3, customer flow line data is automatically correlated with transaction data indicating the contents of items purchased by the customer. Therefore, the time and manpower required for the correlating operation can be greatly reduced.

Further, in the customer behavior monitoring system 3, a certain time range 2θ is set around transaction date and time of flow line data. Transaction data to be correlated is retrieved from a transaction data group including a transaction time within the time range 2θ. Therefore, the amount of data to be retrieved is reduced, and the efficiency of retrieving is increased.

Further, in the customer behavior monitoring system 3, when a non-correlated flow line ID remains as a result of automatic correlating, transaction IDs as correlating candidates for the flow line ID are listed up. Specifically, transaction IDs having transaction date and time Tj within a time range wider than the time range 2θ, around the transaction time and range Ti added to the non-correlated flow line ID, are listed up. When the operator selects a desired transaction ID from the list, the non-correlated flow line ID is correlated with the selected transaction ID.

For a flow line ID not automatically correlated, one of a few transaction IDs selected as a candidate can be manually correlated. Therefore, this correlating operation is easy.

### Embodiment 2

In the first embodiment, each flow line in a flow line ID list and each transaction ID (a terminal number, transaction date and time, and a transaction serial number) in a transaction ID list are combined, so that a difference between the transaction dates and time is minimum. Here, the transaction date and time data added to a flow line ID is the date and time counted by a clock IC built into the flow line server 22. In contrast, the transaction date and time data included in a transaction ID is the date and time counted by a clock IC built into each of the POS terminals 11a and 11b. Thus, even if the time is periodically adjusted, a time difference may occur.

When a time difference occurs, even if a combination in which the difference between the transaction dates and time is minimum, the combination may not be correct. Thus, in the second embodiment, correlating is made while correcting a time difference.

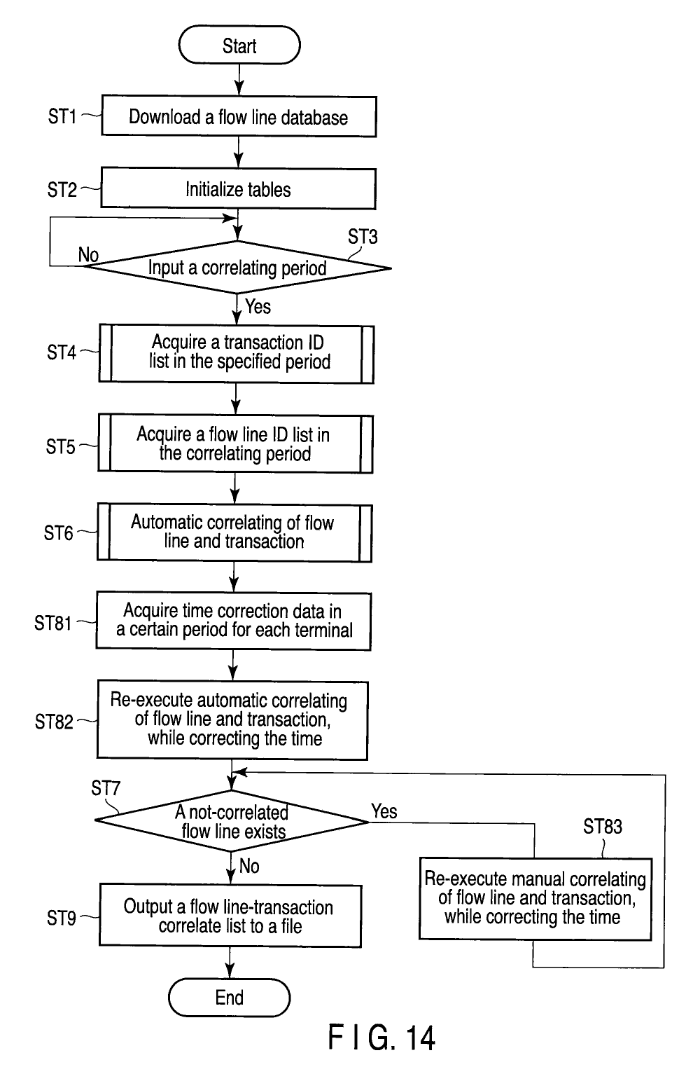

The flowchart of FIG. 14 shows steps of a main process executed by the control unit 37, when a customer behavior monitoring program is started in the second embodiment. In FIG. 14, the steps common to the main process in the first embodiment (FIG. 5) are given the same reference numbers.

When the main process is started in the second embodiment, the operations of steps ST1 to ST6 explained in the first embodiment are executed. The only difference from the first embodiment is the operation of step ST51 (FIG. 9) in the automatic correlating of flow line data and transaction data as step ST6.

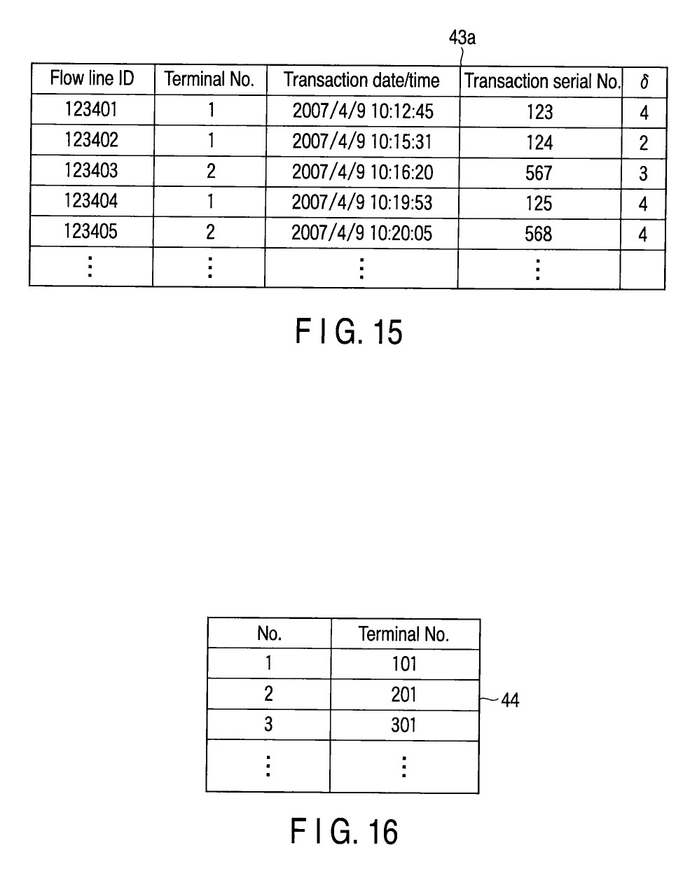

In the second embodiment, in addition to the correlate table 43, a second correlate table 43a having a data structure shown in FIG. 15 is formed in the data storage 35. In step ST51, a flow line ID, a terminal number, transaction date and time, and a transaction serial number of a transaction ID are correlated and stored in the second correlate table 43. An absolute value δ of the difference between the transaction date and time Tj and Ti is also stored in the second correlate table 43a.

Therefore, in the second correlate table 43a, a transaction ID, in which a terminal number coincides with a number added to each flow line ID, and transaction date and time are the date and time closest to the transaction date and time Ti added to the flow line ID, is set together with the absolute value δ of the difference between the transaction date and time Tj and Ti.

After finishing the first automatic correlating process (the first combination unit), the control unit 37 creates time correction data for correcting a time difference that has occurred in a certain period for each unit time, as step ST81. The time correction data is created by a method of least squares, by using the absolute value δ data stored in the second correlate table 43a. Namely, the time correction data is calculated by using a linear equation taking the unit time and absolute value δ as two variables x and y including an error, as an approximation expression.

Here, a certain period means a longer one of the periods for adjusting time in the flow line server 22 and adjusting time in the POS terminals 11a and 11b. For example, assuming that the flow line server 22 adjusts the time every hour, and POS terminals 11a and 11b adjust the time at every 24 hours, a certain period means 24 hours. The time correction data is created for each of the POS terminals 11a and 11b (a correction data creation unit).

After creating the time correction data, the control unit 37 re-executes the automatic correlating process (a second combination unit), while correcting the transaction date and time data in the transaction ID list table 41 and flow line ID list table 42, by the time correction data (a time correction unit).

Namely, in the operations of step ST35, step ST44 and step ST48 in FIG. 9, the control unit 37 executes calculation and comparison for the transaction date and time Tj and Ti, while making correction by the time correction data at respective periods of unit time.

After finishing the second automatic correlating process, the control unit 37 determines whether or not a non-correlated flow line ID exists, as step ST7. When a non-correlated flow line ID exists, the control unit 37 executes a manual correlating process, while correcting the transaction date and time Tj and Ti by the time correction data, as step ST83.

When a non-correlated flow line ID does not exist (NO in step ST7), the control unit 37 outputs the data of the correlate table 43, that is, the data of a correlate list of flow line IDs and transaction IDs, to the output file 36, as step ST9.

As described above, in the second embodiment, the date and time data of the transaction ID list and flow line ID list is corrected based on the time correction data. Each flow line ID in the list of flow line IDs and each transaction ID in the list of transaction line IDs are combined to have a minimum difference between the transaction date and time data in the corrected lists. Therefore, even if a time difference occurs in the time counted by the clock IC, the combined accuracy can be increased.

Further, in the second embodiment, an approximation expression of time correction data is obtained by a method of least squares. A method of obtaining an approximation expression is not limited to a method of least squares.

### Embodiment 3

A terminal number added to each flow line data in the flow line database 24 is determined and input by the operator on the screen of the display unit 32. Thus, a wrong terminal number may be added by mistake in judgment or input.

In the first and second embodiments, correlating is based on a condition that a terminal number added to each flow line ID coincides with a terminal number of a transaction ID. Thus, when a wrong terminal number is added, correct correlating is impossible. Such a defect is prevented in a third embodiment.

In the third embodiment, a terminal number table 44 is formed in the data storage 35. In the terminal number table 44, terminal numbers of POS terminals 11aand 11b are set in ascending order from 1 corresponding to correspondence table numbers, as shown in FIG. 16.

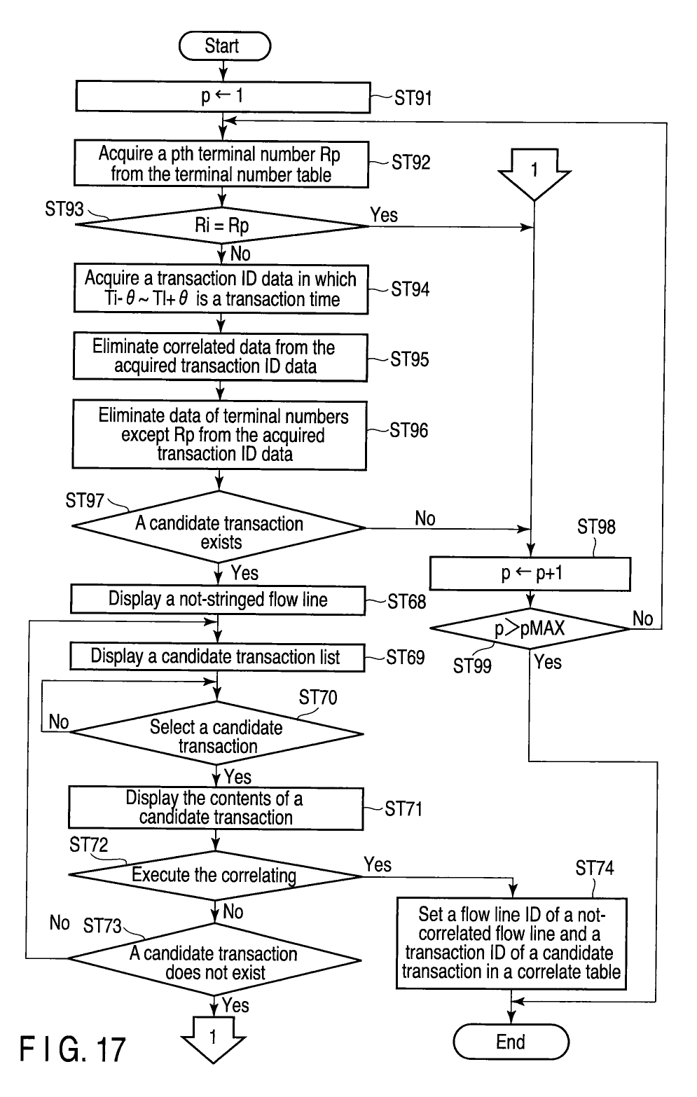

In the third embodiment, when the number of repetitions k exceeds a maximum value kMAX in the manual correlating process in step ST75 shown in FIG. 10, the control unit 37 executes second manual correlating process shown in FIG. 17.

In FIG. 17, “p” indicates the number of repetitions, and “pMAX” indicates a maximum number of repetitions p. A maximum number pMAX coincides a maximum table number in the terminal number table 44, or the number of POS terminals 11a and 11b.

When the second manual correlating process is started, the control unit 37 sets the number of repetitions p to “1”, as step ST91. The control unit 37 regards the number of repetitions p as a table number in the terminal number table 44. The control unit 37 retrieves a terminal number Rp corresponding to a table number p from the terminal number table 44, as step ST92, and determines whether or not the terminal number Rp coincides with a terminal number Ri of a non-correlated flow line ID, as step ST93.

If not, the control unit 37 calculates date and time “Ti−θ”, transaction date and time Ti minus time range θ after expansion, as step ST94. The control unit 37 calculates date and time “Ti+θ”, transaction date and time Ti plus time range θ after the expansion. The control unit 37 retrieves transaction IDs in a period in which the transaction date and time Tj is in a range of “Ti−θ” to “Ti+θ”, as correlating candidates, from the transaction ID list table 41.

After obtaining transaction IDs as correlating candidates, the control unit 37 abandons transaction IDs meeting the following conditions among the candidates, as step ST95 and step ST96. The control unit abandons a transaction ID already set in the correlate table 43, in step ST95, and abandons a transaction ID having a terminal number Rj different from a terminal number Rk retrieved from the terminal number table 44, in step ST96.

The control unit 37 checks whether or not a transaction ID remains as a correlating candidate, as step ST97. When a candidate transaction ID remains, the control unit 37 executes the same operations as steps ST68 to ST74 in the first embodiment.

When the terminal number Rp coincides with the terminal number Ri (YES in step ST93), or when no transaction ID remains as a correlate candidate (NO in step ST97), or when a transaction ID as a correlating candidate is used up (YES in step ST97), the control unit 37 counts up the number of repetitions p by “1”, as step ST98.

After counting up the number of repetitions p, the control unit 37 determines whether or not the number of repetitions p exceeds a maximum value pMAX, as step ST99. When the number of repetitions p does not exceed a maximum value pMAX, the control unit 37 returns to step ST92.

If the number of repetitions p exceeds a maximum value pMAX, the control unit 37 finishes the manual correlating process. In this case, a transaction ID is not correlated with a non-correlated flow line ID.

As described above, first, the customer behavior monitoring system 3 selects a flow line ID data from the flow line ID list table 42. Then, the system 3 extracts a transaction ID having the same terminal number Rj as the flow line ID data from the transaction ID list table 41. Next, the system 3 calculates the time difference δ between the transaction date and time Ti of the flow line ID data and the transaction date and time Tj of the transaction ID. Then, the system 3 combines a transaction ID having a minimum time difference δ with the selected flow line ID.

Next, the customer behavior monitoring system 3 extracts a terminal number Ri of a non-correlated flow line ID from the flow line ID list table 42, and replaces the terminal number Ri with a terminal number Rp of another POS terminal. Then, the system 3 retrieves a transaction ID having the replaced terminal number Rp from the transaction ID list table 41, and displays the retrieved transaction ID as a candidate transaction list. Therefore, even if a wrong terminal number is added to flow line data, a correct transaction ID can be easily correlated with the flow line data.

### Embodiment 4

At a supermarket, two or more customers may visit as a group, for example, parents and children, and couples, and one of the members of the group collectively pays for the merchandise purchased by the group. The customer behavior monitoring system according to the first to third embodiments can correlate transaction data with flow line data of one person who makes payment, but cannot identify a person who buys specific merchandise included in the transaction data.

A customer behavior monitoring system according to a fourth embodiment can identify a person who buys specific merchandise included in transaction data, even when two or more customers, parents and children, or couples visit as a group, and one of members of the group collectively pays for the specific merchandise.

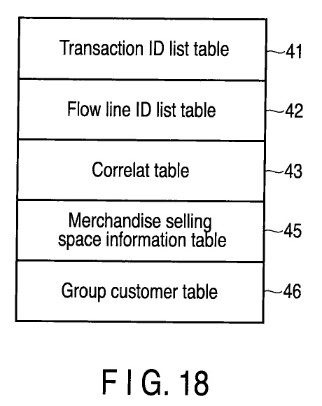

A customer behavior monitoring system 3 according to a fourth embodiment reserves memory areas in a data storage 35 as shown in FIG. 18, that is, a transaction ID list table 41, a flow line ID list table 42, a correlate table 43, a merchandise selling space information table 45, and a group customer table 46. The customer behavior monitoring system 3 stores a customer behavior monitoring program according to the invention, in a program storage 24.

When the customer behavior monitoring program is started, the display unit 32 displays an operation menu screen, which includes “correlating operation” and “group customer analysis”. When the correlating operation is selected, the control unit 37 executes the process shown in the flowchart of FIG. 5, which is explained as a main process in the first embodiment.

Even when two or more customers visit a store as a group, and one of the members of the group collectively pays for the merchandise purchased by other members of the group, the flow line server 22 handles each member of the group as an independent customer. Namely, a flow line ID, a transaction time, and a terminal number are given to the flow line data of each member, and these data are stored in the flow line database 24.

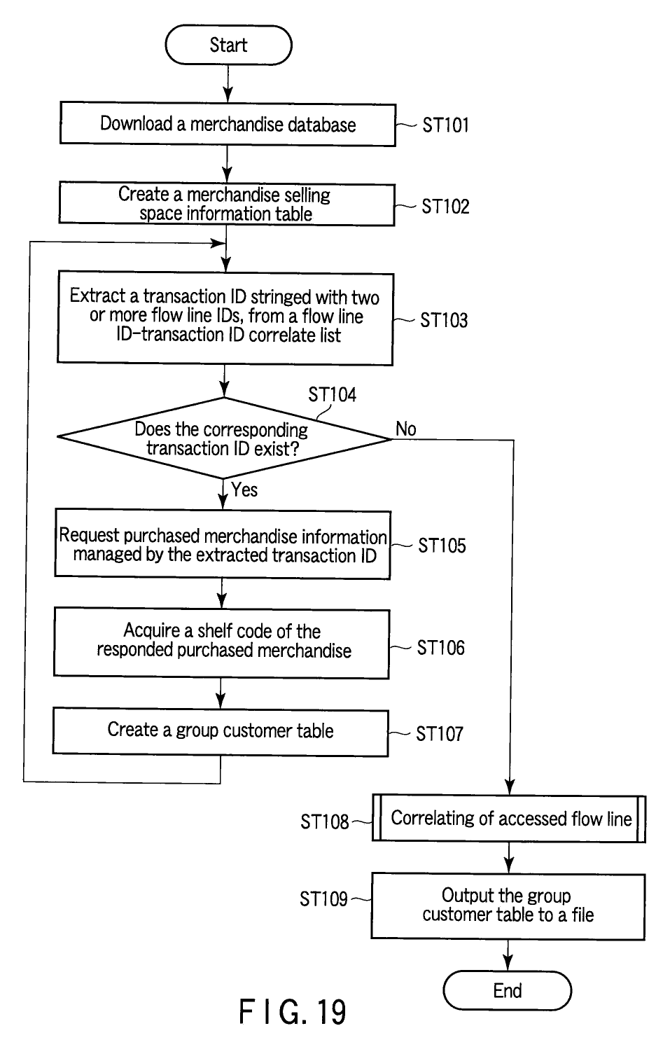

Now, an explanation is given of the group customer analysis. When the group customer analysis is selected, the control unit 37 starts a process shown in the flowchart of FIG. 19.

The control unit 37 requests the POS server 12 to download the merchandise database 14, as step ST101. Receiving the request, the POS server 12 downloads the merchandise database 14 to the customer behavior monitoring system 3. The data of the flow line database 14 downloaded through the communication unit 33 is stored in the data storage 35.

The control unit 37 creates a merchandise selling space information table 45 in the data storage 35, based on the data of the merchandise database 14 downloaded in step ST102.

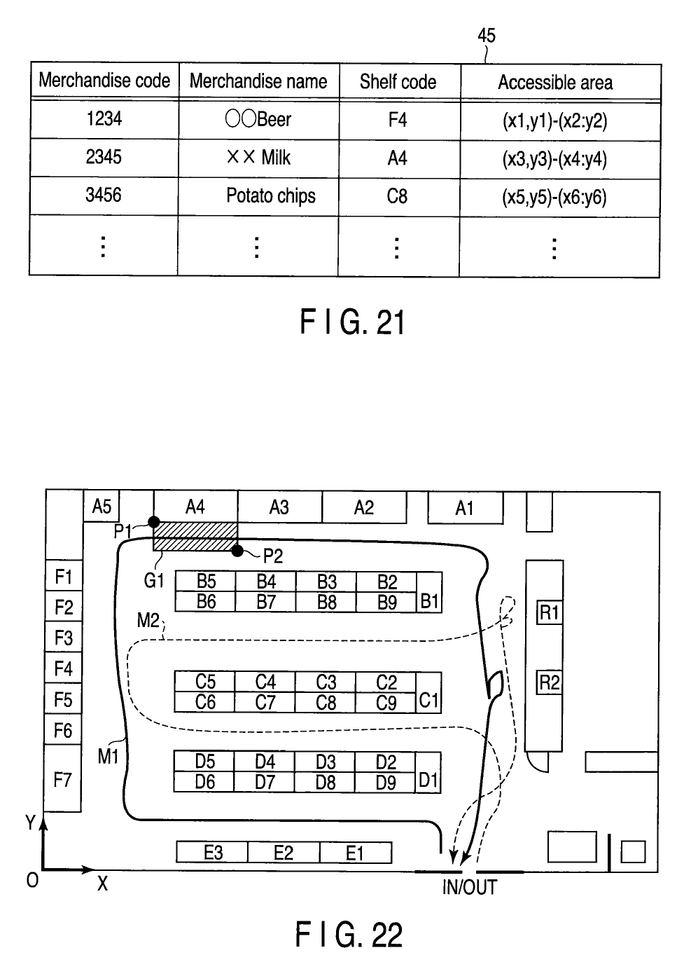

FIG. 21 shows an example of the merchandise selling space information table 45. As shown in the drawing, the merchandise selling space information table 45 includes a merchandise code and name of merchandise, a shelf code, and an accessible area. A shelf code identifies a shelf selling corresponding merchandise. An accessible area is the information to specify an area in a merchandise selling space, which is assumed to be reached by a customer's hand when the customer extends his (her) hand at a location close to a merchandise shelf selling corresponding merchandise. The merchandise code and name of merchandise, shelf code, and accessible area are previously set for individual items of merchandise in the merchandise database 14.

Next, a shelf code and an accessible area will be concretely explained by using FIG. 22. FIG. 22 is a plan view of a floor layout in a store. In FIG. 22, reference numbers A1 to A5, B1 to B9, C1 to C9, D1 to D9, E1 to E3, and F1 to F7 denote shelf codes assigned to merchandise shelves partitioned as shown in the drawing.

In FIG. 22, a hatched square area indicates an area G accessible to the merchandise placed on a merchandise shelf indicated by a shelf code A4. In this embodiment, a plane parallel to the floor of a store is indicated by a two-dimensional coordinate system, in which the horizontal direction in the drawing is taken on an X-axis, the vertical direction is taken on a Y-axis, and the lower-left corner is taken as an origin O (0, 0) of this coordinate system. The square accessible area G is specified by specifying an upper-left point P1 and a lower-right point P2 of the accessible area G by a coordinate value P1 (x, y)-P2 (x, y) of the two-dimensional coordinate system.

The merchandise selling space information table 45 functions as a selling space storage, which stores information about areas for each item of merchandise in a selling space where corresponding merchandise is sold.

In FIG. 22, the reference numbers R1 and R2 denote POS terminals 11a and 11b. The sign “IN/OUT” indicates an entrance/exit of a store. A solid line M1 and a broken line M2 indicate flow lines of customers in a store.

After creating the merchandise selling space information table 45, the control unit 37 extracts a transaction ID, in which two or more flow line IDs are correlated for one transaction ID (a terminal number, transaction date and time, a transaction serial number), as step ST103. This operation refers to a correlate list of flow line IDs and transaction IDs output to the output file 36.

Whenever extracting a transaction ID, in which two or more flow line IDs are correlated for one transaction ID (a terminal number, transaction date and time, a transaction serial number) (YES in step ST104), the control unit 37 executes the operations of steps ST105 to ST107.

In step ST105, the control unit 37 requests the POS server 12 connected through the communication unit 33, to output the purchased merchandise information included in the transaction data specified by a corresponding transaction ID. For this request, the POS server 12 returns codes and names of all purchased merchandise included in the corresponding transaction data.

The control unit 37 retrieves the merchandise selling space information table 45, in order to obtain the selling space information about the purchased merchandise, or shelf codes, returned from the POS server 12, as step ST106. The control unit 37 creates a group customer table 46 in the data storage 35, based on the transaction ID, purchased merchandise information and shelf codes, as step ST107.

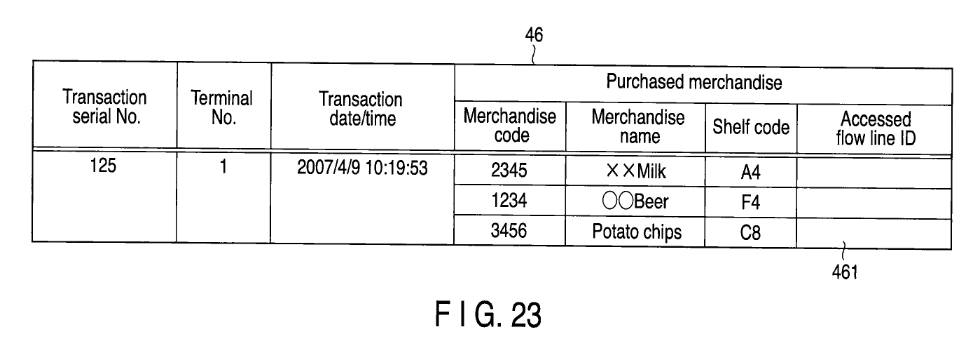

FIG. 23 shows an example of a group customer table 46. As shown in the drawing, the group customer table 46 includes a transaction ID, and merchandise codes and names, and shelf codes of all merchandise purchased in the transaction specified by the transaction ID. An accessed flow line ID area 461 is ensured for each purchased item of merchandise.

As described above, whenever extracting a transaction ID, in which two or more flow line IDs are correlated for one transaction ID, from a correlate list of flow line IDs and transaction IDs, the control unit 37 creates a group customer table 46 in the data storage 35 based on the transaction ID.

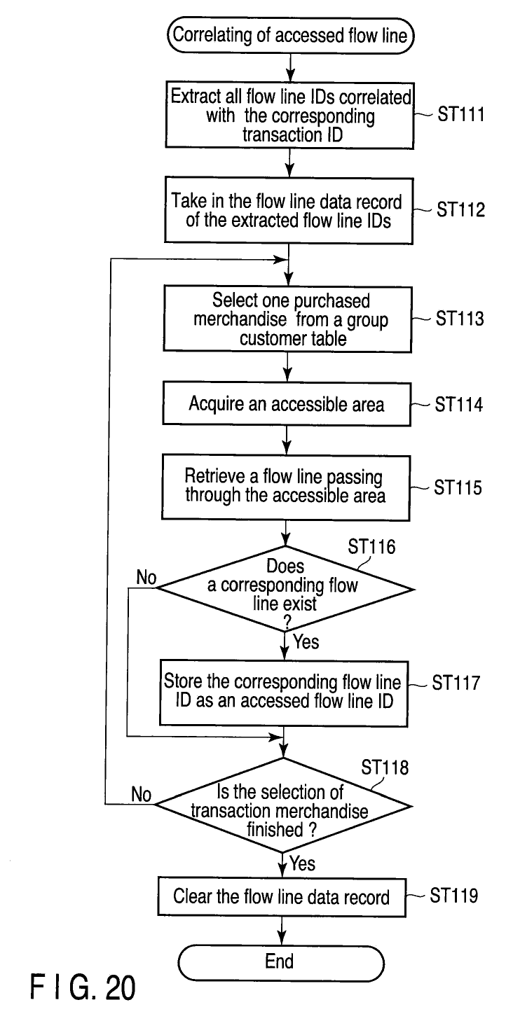

After finishing the extraction of a transaction ID, in which two or more flow line IDs are correlated for one transaction ID (NO in step ST104), the control unit 37 executes correlating of accessed flow line for each group customer table 46, as step ST108. Steps of this process are concretely shown in the flowchart of FIG. 20.

First, the control unit 37 retrieves a correlate list of flow line IDs and transaction IDs in the output file 36, in order to extract all flow line IDs correlated with a transaction ID (a transaction serial number, a terminal number, transaction date and time) stored in the group customer table 46, as step ST111.

The control unit 37 instructs the flow line server 22 to collectively retrieve flow line records identified by the extracted flow line IDs, as step ST112. According to this instruction, the flow line server 22 retrieves the flow line records identified by the extracted flow line IDs, from the flow line database 24, and sends the flow line records to the control unit 37. The control unit 37 stores the flow line records in the data storage 35.

The control unit 37 selects information about one item of purchased merchandise (a merchandise code, a merchandise name, a shelf code) from the group customer table 46, as step ST113. The control unit 37 retrieves the merchandise selling space information table 45, and obtains an accessible area corresponding to the information about the selected merchandise (a selling space acquisition unit).

The control unit 37 traces the flow line data of each flow line record stored in the data storage 35, in order to retrieve a flow line passing in the accessible area G, as step ST115. Flow line data expresses a customer's flow course on a floor layout in a store as a group of points. These points can be indicated by coordinate values (x, y) on the basis of an origin O of a two-dimensional coordinate system expressing a plane parallel to a floor of a store, as in the accessible area G.

The control unit 37 obtains all coordinate values in a square area surrounded by the upper-left coordinate P1 and lower-right coordinate P2 of the accessible area G. The control unit 37 sequentially follows the coordinate value at each point constituting each flow line data. As a result, when detecting any coordinate value of the flow line data overlapping with one of the coordinate values in the accessible area G, the control unit 37 recognizes the flow line data as a flow line passing through the accessible area G (a flow line retrieving unit).

After detecting a flow line passing through the accessible area G (YES in step ST116), the control unit 37 sets the ID of the flow line in the accessed flow line ID area 451 corresponding to the purchased merchandise information selected in step ST113, as step ST117. At this time, if two or more flow lines are detected for one purchased merchandise information, the IDs of the flow line are set in the accessed flow line ID area 451 (a flow line correlating unit).

The control unit 37 determines whether or not unselected purchased merchandise information exists in the corresponding group customer table 46, as step ST118. If the purchased merchandise information exists (NO in step ST118), the control unit 37 returns to step ST113. Namely, the control unit 37 selects one piece of the purchased merchandise information, and re-executes the operations of steps ST114 to ST117.

If unselected purchased merchandise information does not exist (YES in step ST118), the control unit 37 clears the flow line data stored in the data storage 35, as step ST119. This completes the process of correlating accessed flow lines.

After executing the accessed flow line correlating process for all group customer tables 46 created in the data storage 35, the control unit 37 outputs all these group customer tables 46 to the output file 36, as step ST109. Now, the customer behavior monitoring program for the group customer analysis is finished.

It is now assumed that a correlate list of flow line IDs and transaction IDs having the contents shown in FIG. 13 is output. When the group customer analysis is executed in this state, two flow line IDs “123404” and “123405” are correlated with a transaction ID of a transaction serial number 125, and a group customer table 46 for this transaction ID is created. FIG. 23 shows the group customer table 46 created at this time. FIG. 21 shows the merchandise selling space information table 45. The flow line of one flow line ID “123404” is indicated by a reference number M1 in FIG. 22, and the flow line of the other flow line ID “123405” is indicated by a reference number M2 in FIG. 22.

In this case, first, the purchased merchandise “XX Milk” indicated by the merchandise code “2345” is selected from the group customer table 46. The purchased merchandise “XX Milk” is placed on a merchandise shelf indicated by the shelf code “A4”, and an accessible area of this merchandise shelf is (x1, y1)-(x2, y2). By tracking the flow line M1 of the flow line ID “123404” and the flow line M2 of the flow line ID “123405”, it is confirmed that the flow line M1 passes through the accessible area (x1, y1)-(x2, y2). As a result, the flow line ID “123404” is set in the group customer table 46, as an accessed flow line ID for the purchased merchandise “XX Milk”.

Next, the purchased merchandise “oo Beer” indicated by the merchandise code “1234” is selected from the group customer table 46. The purchased merchandise “oo Beer” is placed on a merchandise shelf indicated by a shelf code “F4”, and an accessible area of this merchandise shelf is (x3, y3)-(x4-y4). By tracking the flow line M1 of the flow line ID “123404” and the flow line M2 of the flow line ID “123405”, it is confirmed that both flow lines Ml and M2 pass through the accessible area (x3, y3)-(x4, y4). As a result, the flow line IDs “123404” and “123405” are set in the group customer table 46, as accessed flow line IDs for the purchased merchandise “oo Beer”.

Next, the purchased merchandise “Potato chips” indicated by the merchandise code “2345” is selected from the group customer table 46. The purchased merchandise “Potato chips” is placed on a merchandise shelf indicated by a shelf code “C8”, and an accessible area of this merchandise shelf is (x5, y5)-(x6, y6). By tracking the flow line M1 of the flow line ID “123404” and the flow line M2 of the flow line ID “123405”, it is confirmed that the flow line M2 passes through the accessible area (x5, y5)-(x6, y6). As a result, the flow line ID “123405” is set in the group customer table 46, as an accessed flow line ID for the purchased merchandise “Potato chips”.

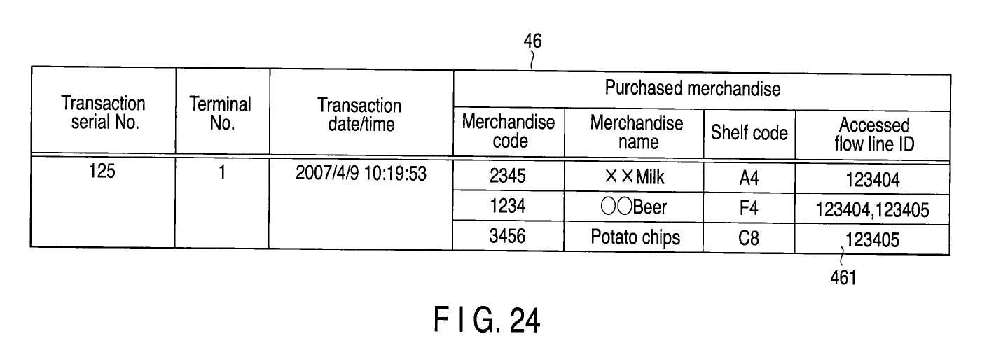

As a result, the group customer table 46 having the contents shown in FIG. 24 is output to the output file 36. According to the information of the group customer table 46, it is proved that among three merchandise purchased by two customers, the “XX Milk” is purchased by the customer identified by the flow line ID “123404”, the “Potato chips” is purchased by the customer identified by the flow line ID “123405”, and the “oo Beer” is purchased by any one of the customers identified by the flow line ID 123404” and “123405”.

For example, when the average stay time of the customer who purchased the “XX Milk” is calculated, the data of the flow line indicated by the flow line ID “123404” corresponding to the customer who purchased the “XX Milk” is used. The data of the flow line indicated by the flow line ID “123405” is not used.

When the average stay time of the customer who purchased the “oo Beer” is calculated, it is unknown which flow line ID, “123404” or “123405” corresponds to the customer who purchased the “oo Beer”. In this case, the average stay time is calculated without using the data of this customer. The certainty of the calculation result is not degraded by this.

The invention is not limited to the embodiments described herein. The invention may be embodied in a practical stage by modifying the constituent elements without departing from its essential characteristics.

For example, in the manual correlating process, a flow line may not be displayed, and images taken by a camera in synchronization with the flow line may be displayed. Correlating can be executed by estimating merchandise purchased by a customer from images taken by a camera.

The output destination of a correlate list of flow line IDs and transaction IDs is not limited to the output file 36. The list may be displayed in the display unit 32, or printed by converting to print data.

In the fourth embodiment, a square accessible area is specified by the coordinates of upper-left and lower-right points. A square accessible area may be specified by an upper-left point and the lengths of vertical and horizontal sides of a square. Namely, a square accessible area may be specified by any method capable of uniquely defining a square. The shape of an accessible area is not limited to a square. An accessible area may be specified by an arc or a polygon, according to the shape of a shelf.

In the fourth embodiment, two or more flow lines, which enter and exit a store from a doorway substantially at the same time, are grouped. In the group customer analysis, a transaction ID correlated with at least one of the flow lines is extracted, and a post-process is executed. The same effects as in the fourth embodiment can be provided by modifying the invention as described above.

In the embodiments described herein, a function of embodying the invention is previously recorded in the system. A similar function may be downloaded from a network. Or, a similar function stored in a recording medium may be installed in the system. A recording medium may be of any form, such as a CD-ROM, capable of storing a program, and readable by the system. Such a function provided by previous installation or download may be realized by cooperating with an operating system (OS) in the system.

The invention is used for analysis of behavior of customers in stores, such as a convenience store or a supermarket.

What is claimed is:

1. A customer behavior monitoring system comprising:
a flow line storage which stores flow line data on each customer obtained by tracking a behavior of each customer in a store, by adding time data on an estimated time of payment made by each customer;
a transaction data storage which stores transaction data for each customer including records of merchandise purchased by each customer, by adding time data on an estimated time of payment made by each customer;
a combination unit which determines a combination in which a difference between the time data is minimum, for each piece of flow line data stored in the flow line storage and each piece of transaction data stored in the transaction data storage; and
a correlating unit which correlates the flow line data and transaction data combined by the combination unit.

2. The customer behavior monitoring system according to claim 1, wherein the flow line storage stores the flow line data for each customer, by further adding terminal identifying information to identify a payment terminal estimated to have handled payment by each customer,
the transaction data storage stores the transaction data for each customer, by further adding terminal identifying information to identify a payment terminal estimated to have handled payment by each customer, and
the combination unit determines a combination in which piece of the terminal identifying information match and a difference between the time data is minimum, for said each piece of flow line data and said each piece of transaction data.

3. The customer behavior monitoring system according to claim 1, further comprising a time correction unit which corrects time data added to the transaction data and flow line data, based on time correction data for correcting a difference in time data,
wherein the combination unit determines a combination, in which a difference between the time data after correction is minimum, for said each piece of flow line data and said each piece of transaction data.

4. The customer behavior monitoring system according to claim 2, further comprising a time correction unit which corrects time data added to the transaction data and flow line data, based on time correction data for correcting a difference in time data,
wherein the combination unit determines a combination in which pieces of the terminal identifying information match and a difference between the time data after correction is minimum, for said each piece of flow line data and said each piece of transaction data.

5. The customer behavior monitoring system according to claim 1, further comprising:
a first combination unit which determines a combination in which a difference between the time data is minimum, for said each flow line data and said each piece of transaction data;
a correction data creation unit which creates time correction data for correcting a time difference occurred in a certain period, from a difference between the time data in each combination of flow line data and transaction data combined by the first combination unit;
a time correction unit which corrects the time data of the transaction data and flow line data, based on the time correction data created by the correction data creation unit; and
a second determination unit which determines a combination in which a difference between the time data after correction is minimum, for said each piece of flow line data and said each piece of transaction data.

6. The customer behavior monitoring system according to claim 2, further comprising:
a first combination unit which determines a combination in which a difference between the time data is minimum, for said each piece of flow line data and said each piece of transaction data;
a correction data creation unit which generates time correction data for correcting a time difference occurring in a certain period, a difference between the time data in each combination of flow line data and transaction data combined by the first combination unit;
a time correction unit which corrects the time data of the transaction data and flow line data, based on the time correction data created by the correction data creation unit; and
a second determination unit which determines a combination in which a difference between the time data after correction is minimum, for said each piece of flow line data and said each piece of transaction data.

7. The customer behavior monitoring system according to claim 1, wherein the combination unit selects flow line data together with time data from the flow line storage, sets a time range around the time of the time data, retrieves transaction data given time data indicating a time within the time range from the transaction data storage, and calculates a time difference between the time data, and makes a combination of flow line data and transaction data in which the time difference is minimum.

8. The customer behavior monitoring system according to claim 1, wherein the combination unit selects flow line data together with time data from the flow line storage, sets a first time range around the time of the time data, retrieves transaction data given time data indicating a time within the first time range, from the transaction data storage, and calculates a time difference between the time data, and makes a combination of flow line data and transaction data in which the time difference is minimum, and then selects flow line data not combined with transaction data together with time data from the flow line storage, sets a second time range larger than the first time range, around the time of the time data, and retrieves transaction data given time data indicating a time within the second time range, of the transaction data not combined with flow line data, from the transaction data storage.

9. The customer behavior monitoring system according to claim 2, wherein the combination unit selects flow line data together with time data and terminal identifying information from the flow line storage, retrieves transaction data having the same terminal identifying information from the transaction data storage, and calculates a difference between the time data, and makes a combination of flow line data and transaction data in which the time difference is minimum, and then selects flow line data not combined with transaction data together with time data and terminal identifying information from the flow line storage, replaces the terminal identifying information with terminal identifying information about another payment terminal, and retrieves transaction data having terminal identifying information after the replacement, in which a difference between the time data is minimum, of the transaction data not combined with flow line data, from the transaction data storage.

10. A customer behavior monitoring method comprising:
a flow line storage stores flow line data of each customer obtained by tracking behavior of each customer in a store, by adding time data on an estimated time of payment made by each customer;
a transaction data storage stores transaction data for each customer including records of merchandise purchased by each customer, by adding time data on an estimated time of payment made by each customer;
a combination unit determines a combination in which a difference between the time data is minimum, for each piece of flow line data stored in the flow line storage and each piece of transaction data stored in the transaction data storage; and
a correlating unit correlates the flow line data and transaction data combined by the combination unit.

11. The customer behavior monitoring method according to claim 10, wherein the flow line storage stores the flow line data for each customer, by further adding terminal identifying information to identify a payment terminal estimated to have handled payment by each customer,
the transaction data storage stores the transaction data for each customer, by further adding terminal identifying information to identify a payment terminal estimated to have handled payment by each customer, and
the combination unit determines a combination, in which pieces of the terminal identifying information match and a difference between the time data is minimum, for said each piece of flow line data and said each piece of transaction data.

12. The customer behavior monitoring method according to claim 10, further including a time correction unit that corrects time data added to the transaction data and flow line data, based on time correction data for correcting a difference in time data,
wherein the combination unit determines a combination, in which a difference between the time data after correction is minimum, for said each piece of flow line data and said each piece of transaction data.

13. The customer behavior monitoring method according to claim 11, further comprising a time correction unit that corrects time data added to the transaction data and flow line data, based on time correction data for correcting a difference in time data,
wherein the combination unit determines a combination, in which the terminal identifying information is matched and a difference between the time data after correction is minimum, for said each piece of flow line data and said each piece of transaction data.

14. A customer behavior monitoring program for enabling a flow line management system which manages flow line data of each customer obtained by tracking a behavior of each customer in a store, by adding time data on an estimated time of payment made by each customer, and a computer connected to a transaction management system which manages a transaction of each customer by adding time data on an estimated time of payment made by each customer, to transaction data for each customer having records of items purchased by each customer, to realize:
a function of determining a combination in which a difference between the time data is minimum, for each piece of flow line data managed by the flow line management system and each piece of transaction data managed by the transaction monitoring system; and
a function of correlating the flow line data and transaction data combined by the function of determining a combination.

15. The customer behavior monitoring program according to claim 14, wherein terminal identifying information to identify a payment terminal estimated to have handled payment by each customer is added to flow line data for each customer managed by the flow line management system,
terminal identifying information to identify a payment terminal estimated to have handled payment by each customer is added to transaction data for each customer managed by the transaction monitoring system, and
the function of determining a combination determines a combination, in which pieces of the terminal identifying information match and a difference between the time data is minimum, for said each piece of flow line data and said each piece of transaction data.

16. The customer behavior monitoring program according to claim 14, enabling the computer to further realize a function of correcting time data in the transaction data and flow line data, based on time correction data for correcting a difference in time data,
wherein the function of determining a combination determines a combination, in which a difference between the time data after correction is minimum, for said each piece of flow line data and said each piece of transaction data.

17. The customer behavior monitoring program according to claim 15, enabling the computer to further realize a function of correcting time data in the transaction identification list and flow line identification list, based on time correction data for correcting a difference in time data,
wherein the function of determining a combination determines a combination, in which pieces of the terminal identifying information match and a difference between the time data after correction is minimum, for said each piece of flow line data and said each piece of transaction data.

18. A customer behavior monitoring system comprising:
a selling space storage which stores information to identify a selling space for each merchandise;
a correlating unit which correlates flow line data obtained by tracking each member of a group, with transaction data including records of items purchased by customers visiting a store as a group;
a selling space acquisition unit which acquires information to identify a merchandise selling space for each item of purchased merchandise included in the transaction data, from the selling space storage;
a flow line retrieving unit which retrieves flow line data passing through a selling space identified by the information acquired by the selling space acquisition unit, from the flow line data correlated with the transaction data; and
a flow line correlating unit which correlates the flow line data retrieved by the flow line retrieving unit, with each item of purchased merchandise included in the transaction data.

19. The customer behavior monitoring system according to claim 18, wherein the selling space storage stores information indicating an area of merchandise selling space for each merchandise, which is assumed to be reached by a hand of a customer.

20. A customer behavior monitoring program for enabling a computer having a selling space storage which stores information to identify a selling space for each item of merchandise, to realize:
a function of correlating flow line data obtained by tracking each member of a group, with transaction data including records of items purchased by customers visiting a store as a group;
a function of acquiring information to identify a merchandise selling space for each item of purchased merchandise included in the transaction data, from the selling space storage;
a function of retrieving flow line data of passage through a selling space identified by the information acquired by the acquiring function, from the flow line data correlated with the transaction data; and
a function of correlating the flow line data retrieved by the retrieving function, with each item of purchased merchandise included in the transaction data.
